(19) United States
(12) Patent Application Publication
(10) Pub. No.: US 2003/0026923 A1
(43) Pub. Date: Feb. 6, 2003

(54) Integrated monopole reinforcement sleeve system and method

(76) Inventors: Khaled A. Al-Zoubi, Raleigh, NC (US); Ibrahim Hathout, Mississauga (CA)

Correspondence Address: JINAN GLASGOW, P O BOX 28539, RALEIGH, NC, 276118539

(21) Appl. No.: 09/858,402

(22) Filed: May 16, 2001

(51) Int. Cl. B32B 1/08

(52) U.S. Cl. 428/34.1

(57) ABSTRACT

An integrated, monopole reinforcement sleeve system for the reinforcement of self-supporting monopoles at select, predetermined locations. The integrated, monopole reinforcement sleeve system is composed of at least one pair of complementary hemi-sleeves and a non-slip filler, wherein the filler is inserted between the sleeves and the monopole. The sleeves are tightened around the monopole, thereby providing integrated monopole reinforcement. A method for the reinforcement of monopoles with an integrated reinforcement sleeve is also described.

### BACKGROUND OF THE INVENTION

1. Field of the Invention

The present invention relates generally to reinforcement of monopoles and, more particularly, to an integrated monopole sleeve system and method for reinforcement of the monopole at select, predetermined locations.

2. Description of the Prior Art

Monopoles are widely employed as supports for antennae and other devices for wireless communication. They are also used to supports conductors in power transmission. An increase in the use of wireless communication has led to an increased demand for monopole capacity. Existing monopoles are thus being employed to elevate increasing numbers of antennae and other devices for wireless communication, often beyond the rated capacity of the monopoles. These monopoles are therefore prone to fail, resulting in damage to the monopole and supported equipment and loss of service to the users.

Self-support monopoles are tapered or stepped. Stepped monopoles are formed by joining together monopoles of various diameters. Diameter and wall-thickness increases as the distance from the apex increases to reduce the overall weight and expense of the monopole and allow the self-supporting monopoles to act as cantilevers when the loads travel to the ground in a bending mode. The maximum moment is always at ground level. Therefore, the moment and strength of the monopole decrease towards the apex. Further, monopoles are flexible structures that can undergo large deflection, at the apex, of up to 10% of their height under maximum loads. Since monopoles normally support appurtenances near the apex, the bending moment at any location along the height is the vector sum of primary moment and secondary moment. The primary moment at a specific location is due to wind load on the projected areas of the appurtenances, pole, platforms, etc while the secondary moment is due to all weights above that location as they deflect from the vertical position. The secondary moment is usually very significant for tall monopoles due to the large top deflection. Since the moment increases as the distance from the apex increases, any additional appurtenances or devices, such as antennas, microwave dishes, mounting platforms or brackets, transmission lines, lights, reflectors, signs, flags, and the like not accounted for in the design of the structure may cause structural failures. Because the function of the monopole is to elevate appurtenances above the ground, and therefore the majority of the appurtenances are attached at or near the apex of the monopole, these present a greater projected area at or near the apex of the monopole and thereby increasing the bending stress or inertial moment in the area of least strength of the monopole. These devices may add approximately between 500 to 4000 lbs weight to the monopole. This weight is not excessive under low wind conditions because the weight is supported axially through the centerline of the monopole. However, under higher wind conditions, these appurtenances add to the secondary moment of the monopole. Therefore, as wind speed increases, the bending stress increases in a disproportionately greater manner due to the addition of the weight of the appurtenances to the bending stress of the monopole.

Monopoles were originally designed to house wave-guides or coaxial cables internally, allowing them to exit through portholes at the apex of the monopole in proximity of the antennas. However, monopoles so designed are now being employed to support a number of wave guides beyond their internal capacity. These wave-guides must therefore be attached externally to the monopole and thus require an external support. Additionally, these external wave-guides increase the projected area of the monopole.

Therefore, a need exists to support or reinforce the monopoles such that they can support more appurtenances at or near the apex and not fail under adverse conditions, such as high winds.

Several solutions to this need have been proposed, including splints, guy wires, various types of sleeves, and other braces. Some of these prior art reinforcing supports were initially developed for wooden poles or lattice tower structures, not for metallic or composite monopoles elevating a plethora of devices. Therefore, they either support the monopole inadequately or not at all. Other prior art reinforcing supports that may be used as monopole supports were originally designed to be applied in close proximity of the ground, utilizing ground insertion as additional support. They are designed more for stabilizing the entire monopole relative to the ground than providing bending resistance at elevated locations of the monopole. Thus, they are not optimally configured for freestanding reinforcement of the monopole at higher elevations. Some prior art devices require considerable time for installation, and are therefore not well suited for application at elevated heights due to the inherent danger of working at these heights. Others require highly skilled technicians to apply the support, resulting in an increased cost of installation and/or improper installation.

Guy lines are also employed to provide reinforcement to monopoles. However, these require a large area at the base of the monopole, create an obstacle for vehicles and persons, and are not suitable for the attachment of appurtenances at elevation.

Some prior art devices can extend for a considerable length along the monopole, but apply the bracing force to small areas of the monopole and to the device. These devices subject the monopole and themselves to increased forces in small, focused area, thus increasing the wear and fatigue of both the monopole and device in these areas.

Thus, there remains a need for a monopole reinforcing system that is easy to install at any elevation on the monopole, can distribute the reinforcing forces uniformly over the monopole circumference, and can provide support for appurtenances.

### SUMMARY OF THE INVENTION

The present invention is directed to an integrated monopole sleeve system and method for reinforcement of the self-supporting monopole at select, predetermined locations.

These and other aspects of the present invention will become apparent to those skilled in the art after a reading of the following description of the preferred embodiment when considered with the drawings.

### BRIEF DESCRIPTION OF THE DRAWINGS

FIG. 1 is a cross-sectional end view of a reinforcing sleeve constructed according to the present invention.

FIG. 2 includes two more cross-sectional end views and a cross-sectional side view of a reinforcing sleeve, and a side view of the end flange of the preferred embodiment according to the present invention.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

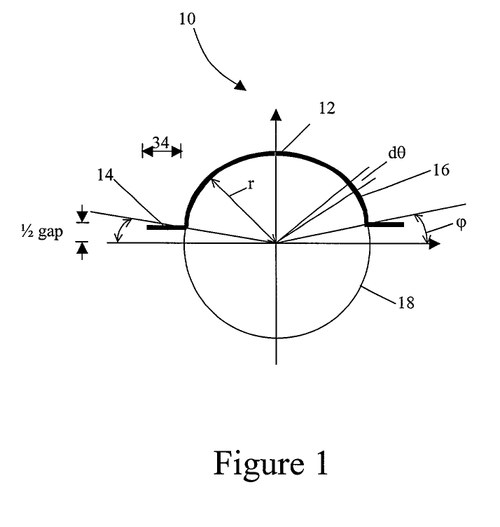

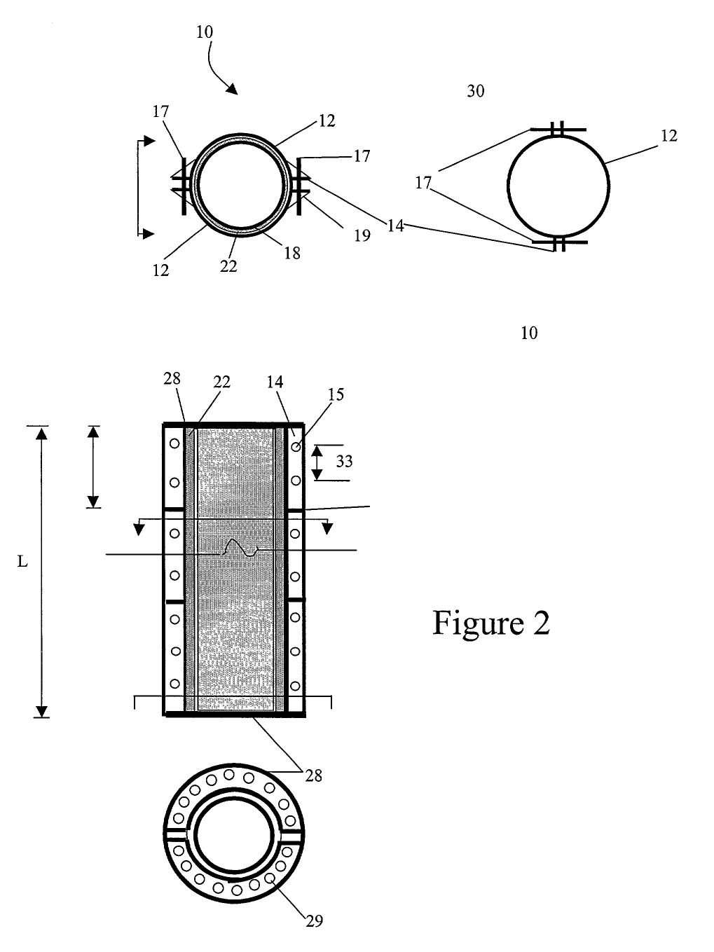

Referring now to the drawings in general, the illustrations are for the purpose of describing a preferred embodiment of the invention and are not intended to limit the invention thereto. As seen in FIGS. 1 and 2, an integrated monopole reinforcement sleeve system, generally referenced as 10, includes at least one pair of reinforcing complementary hemi-sleeves 12 with flanges 14. The flanges 14 are of width 34 and equipped with holes 15, through which bolts 17 or other fasteners can be inserted to join the complementary hemi-sleeves. These bolts or fasteners are then tightened such that the hemi-sleeves form a reinforcing sleeve around the monopole. The flanges may be fitted with a reinforcing brace 19 in order to be able to apply more compressive force to the sleeve assembly prior to the flanges deflecting. As best shown in FIG. 1, the cross-sectional shape 16 of the sleeve 12 approximates the shape of the monopole outer edge or perimeter 18. This perimeter can be circular or multi-sided, such as polygonal-shaped, for example hexagonal or octagonal. FIG. 1 shows a cross-section of a preferred embodiment according to the present invention designed to reinforce a monopole with a circular shaped perimeter. The sleeve is installed at a predetermined location on the monopole for optimal reinforcement of the structure. If necessary, multiple sleeves may be installed on the monopole.

The sleeve is designed such that it fits snugly around the monopole. To enhance the snugness of the fit and thereby increase the reinforcement of the monopole, a compressible material 22 with non-slip or shear force transfer properties can be positioned between the sleeve and the monopole. This material may also serve as a gasket to prevent the rubbing of metal against metal, to reduce the roughness of the monopole surface, and to ensure good distribution of loads between the existing monopole and sleeve along the circumference of the pole. The sleeve is thus compressed around this material and the monopole. The compressibility of the material allows the reinforcing force of the sleeve to be distributed more uniformly across the surface of the monopole. The non-slip properties of the snugging material prevent the sleeve from slipping or shifting position. Monopoles and other elongated structures tend to have a modulus of elasticity that allows them to deflect and vibrate under wind pressure. Therefore, a compressible and non-slip material with elastic properties that acts as a damper to dissipates energy and prevents the slippage between the sleeve and the monopole may be disposed at selected locations between the sleeve and the monopole for ensuring transfer of loads therebetween.

For example, neoprene may be used as the shear force transfer material. However, other types of materials can be used, such as elastomers, polymers, foams, and adhesives. In general, the sleeves do not need to be removed once installed. Therefore, semi-permanent materials such as adhesives can be used. For example, a thick strip of a resilient polymeric material having an adhesive coating could be mounted in an axial or spiral fashion about the monopole to effect transfer of shear forces between the sleeve and the monopole. Also, an expansive foam material, for example neoprene foam, could be injected in the space between the sleeve and monopole.

Tightening the sleeve around the monopole will considerably increase the bending resistance of the pole. The system is now composed of two concentric, adherent cylinders, which are much stronger and thus better resist bending than one cylinder alone.

If the thickness of the monopole and sleeve are the same, then the monopole in the area of the sleeve would have about twice the bending resistance of the monopole alone. Since self-supporting monopoles are subjected to primary bending, then the total bending resistance would approximate the sum of the bending resistance of the pipe and sleeves.

When the two sleeves are properly installed and tightly hugging the monopole, the monopole will have increased resistance to shear forces or transverse load because the sleeve and monopole are in contact through the hard neoprene gasket.

Such a system for the distribution and absorption of force according to the preferred embodiment is in contrast to other reinforcing systems in which the reinforcing force is applied directly to small areas of the monopole, rather than the entire sleeve. Thus, the system according to the preferred embodiment will supply reinforcing support distributed over a large area under normal conditions, and also absorb shock forces over a large area under extreme flexure conditions. These properties prevent a smaller area of the monopole and sleeve from experiencing extreme force and wear, and thus the system according to the preferred embodiment does not fail as readily as other reinforcing systems and extends the functional life of the monopole.

In the preferred embodiment, neoprene is used as the shear force transfer material. Neoprene is used because of its compressibility, elasticity, surface adherence, and resistance to inclement weather, such as extreme temperatures and humidity. Other materials with these properties may be used, such as synthetic polymers, foams, and adhesives.

Thus, an integral sleeve including the reinforcing sleeve, snugging material, and monopole is formed, as is shown in FIG. 2, which provides reinforcing support, stability of position, and shock absorption. The sleeves can be used for a variety of types of monopoles, including constant diameter poles, also known as stepped poles, tapered poles, and the like.

Monopoles are frequently used as supports for appurtenances, such as antennas, mounting platforms or brackets, transmission lines, ladders, lights, reflectors, signs, flags, and the like. These appurtenances can be weighty and confer a larger project area to the monopole, and therefore may locally overstress the monopole if attached without additionally supporting the monopole. In such cases, a sleeve according to the preferred embodiment can be fitted to the monopole at the location where the appurtenance is to be mounted, and then the appurtenance is mounted to the reinforcing sleeve. Thus, the reinforcing sleeve is appropriately constructed with mounting supports to which appurtenances can be mounted. For example, in the preferred embodiment, the bolts used to tighten the sleeves can be used as mounting supports for wave guides, ladders, or step bolts.

These mounting supports can be of different shapes and methods, according to the appurtenances to be mounted. The reinforcing sleeve can include an initial excess of mounting supports at installation, such that additional appurtenances can be mounted to the reinforcing sleeve later without necessitating the replacement of the reinforcing sleeve. For example, the sleeves can be provided with middle flanges to mount appurtenances. Alternately or additionally, the sleeves may be provided with end flanges 28 equipped with holes 29. In these cases, the dimensions of the holes on the sleeve end flanges must match those on the existing flanges of the monopole and the holes on the sleeve end flanges must be oversized or slotted to allow tightening the sleeves. Additionally, to accommodate any openings in the existing pole, the sleeve should have matching oversized openings, preferably about ½ inch wider, to allow for tightening the sleeves. For example, step bolts that have been threaded into bolt-supports welded to the monopole can be easily removed by unthreading them. However, the bolt supports project out of the monopole surface and therefore the sleeve should have matching oversized opening. Alternately, one can use a thicker neoprene gasket or mechanically remove the projected bolt supports.

While it may be desirable to provide the sleeves with end flanges to be bolted to the existing pole-flanges of stepped monopoles, they are not essential, particularly if the end flanges make the installations difficult or risky. Removing the end flanges will considerably simplify the detailing and installations of the sleeves. The sleeve would then act in a similar manner to the plates used to reinforce angles in lattice towers where the plates are stitch-bolted to the legs of the angles. The bond between the angle and the reinforcing plates in the lattice towers is more critical because the loads traveling through the angles are axial while the loads on monopoles are transmitted to the ground through bending.

The location of the overstressed regions of the monopole can be determined by calculation. The calculated cross-sectional area and moment of inertia of the monopoles, sleeves, and reinforced monopoles for stepped-type monopoles according to a preferred embodiment of the present invention shown in FIGS. 1 and 2 with diameters ranging from 24 to 54 inches are displayed in Table 1. In the calculations shown in the attached spreadsheet, the wall-thickness of the sleeves is assumed to be the same as those of the existing monopole sections. To reduce the weight of the sleeves, a thinner wall-thickness and higher steel grade such as grade 60 ksi instead of grade 45 ksi may be used. This may results in lighter sleeves for ease of installation. The formulas used for the calculations are as follows:

The sleeve cross-sectional area, A, as best shown in FIG. 2, is calculated as

A=Aₛ+A_{F}

Where As is the area of the sleeve and AF is the area of the fins.

A_{F}=4t L

Where t (not shown) and L are the thickness and length of the fin, respectively.

dAₛ=t r d θ

Where r is the radius and θ is the angle shown in FIG. 1.

$${A}_{S} = 2 {\int }_{ϕ}^{( π - ϕ )} t r ⅆ θ = 2 t r ( π - 2 ϕ )$$

Where Φ is the tan⁻¹ (gap/2r), where the gap is the distance between the vertical fins of the sleeves. The distance contributed by one sleeve is shown as ½ gap in FIG. 1.

Integration leads to

Aₛ=2t r(π−2Φ

Then, the area of the fins and sleeve is given by

A=4t L+2t r (π−2Φ

The moment of Inertia, I, is calculated thus:

I=Iₛ+I_{F}

Where Iₛ is the moment of Inertia of the sleeve and I_{F} is the moment of Inertia of the fins, respectively.

$${I}_{F} = 4 [ L {t}^{3} / 12 + L {t ( r sin ϕ )}^{2} ]$$

$$d {I}_{S} = ( r ⅆ θ ) {t ( r sin θ )}^{2}$$

$$d {I}_{S} = {r}^{3} t {sin}^{2} θ d θ$$

$${I}_{S} = 2 {\int }_{ϕ}^{( π - ϕ )} t {r}^{3} {sin}^{2} θ d θ$$

Integration leads to

Iₛ=t r³ [π−2Φ+sin(π−2Φ)]

Then, the moment of inertia of the fins and sleeve is given by:

I=4 [ [symbol] −L t³/12+L t(rsin Φ)²]+t r³ [π−2 Φ+sin(π2Φ]

Referring now to Table 1, an evaluation of the increase in moment of inertia provided by the preferred embodiment indicates that a reinforcing system according to the preferred embodiment which employs a sleeve of the same thickness as the monopole would increase the moment of inertia over 100% along the weak axis of the sleeve, in effect more than doubling the moment of inertia along the direction of the weak axis of the sleeve. It should be noted that the increase in moment of inertia along the direction of the strong axis of the sleeve will be greater than this calculated increase, and thus the sleeves should be oriented to provide the maximum bending resistance against loads, such as appurtenances and/or prevailing winds.

TABLE 1
Moments of Inertia for Sleeve-reinforced Monopoles According to the Present Invention.
Existing Monopole

| | | | | | | | |
|---|---|---|---|---|---|---|---|
| Outside Diameter | in | 24 | 30 | 36 | 42 | 48 | 54 |
| Thickness | in | 0.25 | 0.3125 | 0.375 | 0.375 | 0.375 | 0.375 |
| Inside Diameter | in | 23.5 | 29.375 | 35.25 | 41.25 | 47.25 | 53.25 |
| Area | in² | 18.65321 | 29.14563 | 41.96971 | 49.0383 | 56.10688 | 63.17546 |
| Moment of Inertia | in⁴ | 1315.343 | 3211.285 | 6658.921 | 10621.58 | 15908.27 | 22709.85 |

Reinforcing Sleeve - Weak Axis^{1,2}

| | | | | | | | |
|---|---|---|---|---|---|---|---|
| Neoprene thickness | in | 0.25 | 0.25 | 0.25 | 0.25 | 0.25 | 0.25 |
| Inside Diameter | in | 24.5 | 30.5 | 36.5 | 42.5 | 48.5 | 54.5 |
| Angle phi | (radians) | 0.081724 | 0.065621 | 0.054822 | 0.047076 | 0.041249 | 0.036705 |
| Sleeve thickness | in | 0.25 | 0.3125 | 0.375 | 0.375 | 0.375 | 0.375 |
| Area Sleeve | in² | 18.42728 | 28.98639 | 41.92617 | 48.99713 | 56.06748 | 63.13743 |
| Area Fins³ | in² | 8 | 8 | 8 | 8 | 8 | 8 |
| Total Area (S1. + Fin) | in² | 26.42728 | 36.98639 | 49.92617 | 56.99713 | 64.06748 | 71.13743 |
| Sleeve m. of Inertia | in⁴ | 1488.076 | 3589.539 | 7383.408 | 11606.05 | 17192.48 | 24333.56 |
| Flange m. of Inertia | in⁴ | 8.166667 | 8.166667 | 8.166667 | 8.166667 | 8.166667 | 8.166667 |
| Total m. of Inertia | in⁴ | 1496.242 | 3597.706 | 7391.575 | 11614.21 | 17200.65 | 24341.73 |

Reinforced Pole

| | | | | | | | |
|---|---|---|---|---|---|---|---|
| Moment of Inertia | in⁴ | 2811.585 | 6808.991 | 14050.5 | 22235.79 | 33108.92 | 47051.58 |
| Increase reinforced | % | 113.7531 | 112.0332 | 111.0026 | 109.3454 | 108.1239 | 107.1858 |
| pole inertia | | | | | | | |

¹Gap between reinforced sleeves = 2 inches.
²Moment of Inertia is calculated around the weak axis.
³Fin length = 4 inches; fin thickness = ½ inch.

As can be observed by the reader, a proper installation is necessary to maximize the bending resistance conferred by the integral sleeve system. Therefore, an installation procedure should be written and approved by an appropriately qualified engineer for the safe and proper installation of the sleeves prior to the commencement of installation. A typical installation procedure is as follows:

1. Calculate the stresses along the monopole length according to the applicable code, such as the EIA/TIA latest revision for antenna structures or ASCE for Power line structures;

2. Identify the locations of the monopole requiring reinforcement;

3. Design the sleeve required to reinforce the monopole consistent with these calculations, including designing the thickness of the sleeve such that the maximum utilization of the reinforced monopole does not exceeds 80%;

4. Remove projected items such as step bolts, ladder or antenna supports, or coax cables;

5. Clean the surface of the monopole where the sleeves are to be installed;

6. Install the neoprene gasket and hold it in place using a temporary tie or robe;

7. Install the sleeves:

7.1. If the sleeves have flanges for bolting to the existing flanges of a stepped monopole section, remove only half the nuts and bolts of the monopole flanges, including upper and lower flanges, to allow one part of the sleeve to be bolted to the monopole flanges. After securing part 1 of the sleeve in place, remove the other half of the nuts and bolts from the monopole upper and lower flange and install the second half of the sleeve. Secure the sleeve to the monopole flanges. In this case temporary guys above the section being reinforced should be used for safety.

7.2. If the sleeve has no flanges, then the two parts of the sleeve can be lifted and secured in the appropriate location on the monopole.

7.3. Install the threaded bolts along the vertical fins and tighten the two parts of the sleeves using two nuts. The oversized holes on the sleeve flanges, if used, should ensure tight fit between the monopole and the sleeve.

It should be noted the preceding procedure must be discussed with the construction foreman and may be modified to suit site condition and available construction equipment.

Certain modifications and improvements will occur to those skilled in the art upon a reading of the foregoing description. By way of example, different materials can be used to form the sleeves, including non-metallic composites. All modifications and improvements have been deleted herein for the sake of conciseness and readability but are properly within the scope of the following claims.

We claim:

1. An integrated, monopole reinforcement sleeve system, comprising:
at least one pair of complementary hemi-sleeves; and
a non-slip filler;
wherein the filler is inserted between the sleeves and the monopole; and
the sleeves are tightened around the monopole;
thereby providing integrated monopole reinforcement.

2. The system according to claim 1, wherein the sleeves include flanges for fastening the sleeves to the pole flanges of stepped monopoles.

3. The system according to claim 1, wherein the sleeves are shaped to approximated the shape of the monopole surface.

4. The system according to claim 3, wherein the sleeves have a circular shape.

5. The system according to claim 3, wherein the sleeves have a non-circular shape.

6. The system according to claim 5, wherein the non-circular shape is a polygonal shape.

7. The system according to claim 3, wherein sleeves are located at a predetermined, select position on the monopole for optimal reinforcement.

8. The system according to claim 1, wherein the at least one pair of complementary hemi-sleeves are multiple pairs of complementary hemi-sleeves.

9. The system according to claim 1, wherein the filler is an elastic polymer.

10. The system according to claim 1, wherein the filler is selected from the group consisting of polymers, foams, adhesives, and combinations thereof.

11. The system according to claim 1, wherein the filler is neoprene.

12. The system according to claim 1, wherein the filler forms an integral sleeve-snugging material-monopole.

13. The system according to claim 1, further including a mounting support incorporated into the sleeves for the mounting of appurtenances.

14. The system according to claim 13, wherein the mounting support is selected from the group consisting of supports for antennas, microwave dishes, mounting platforms, mounting brackets, transmission lines, lights, reflectors, signs, flags, and combinations thereof.

15. A method for the reinforcement of monopoles with an integrated reinforcement sleeve, including the steps of:
Calculating the stresses along the monopole length according to the applicable code;
identifying the locations of the monopole requiring reinforcement;
designing the sleeve required to reinforce the monopole consistent with these calculations, including designing the thickness of the sleeve such that the maximum utilization of the reinforced monopole does not exceeds 80%; and
installing the sleeve on the monopole at the predetermined locations;
thereby providing an integrated reinforced monopole and sleeve system.
